(19) United States
(12) Patent Application Publication
(10) Pub. No.: US 2022/0366495 A1
(43) Pub. Date: Nov. 17, 2022

(54) SYSTEMS AND METHODS FOR DIGITAL ASSET MANAGEMENT COMPRISING PHYSICAL DIGITAL ASSET HOLDERS

(71) Applicant: Jonathan Gottehrer, Massapequa, NY (US)

(72) Inventor: Jonathan Gottehrer, Massapequa, NY (US)

(21) Appl. No.: 17/744,564

(22) Filed: May 13, 2022

Related U.S. Application Data
(60) Provisional application No. 63/188,348, filed on May 13, 2021.

(51) Int. Cl. G06Q 40/04; G06F 21/10; G06Q 20/38

(52) U.S. Cl. CPC G06Q 40/04; G06F 21/10; G06Q 20/38

(57) ABSTRACT

Various implementations of systems and methods for digital asset management comprising physical digital asset holders are disclosed, wherein a physical digital asset holder may serve as a digital asset custodian, may facilitate a digital asset custodial service and/or may facilitate access or use of a digital asset held thereby. In some implementations, the system may comprise physical digital asset holders which may receive, hold and transfer digital assets, such as for example, cryptocurrencies, non-fungible tokens (NFTs) and the like. In some implementations, physical digital asset holders may be embodied in a plurality of physical forms such as digital playing cards, digital coins, digital payment cards, digital picture frames, digital figurines and the like.

### CROSS-REFERENCE TO RELATED APPLICATIONS

This application claims the benefit of U.S. Provisional Application No. 63/188,348, filed May 13, 2021, entitled Systems, Methods and Devices for Managing and Using Digital Assets in Transferable Physical Form, which is incorporated by reference herein in its entirety.

### FIELD OF THE DISCLOSURE

The present disclosure relates to management of digital assets, and more particularly relates to systems and methods for digital asset management comprising physical digital asset holders, wherein a physical digital asset holder may serve as a digital asset custodian, may facilitate a digital asset custodial service and/or may facilitate access or use of a digital asset held thereby.

### SUMMARY

Various implementations of systems and methods for digital asset management comprising physical digital asset holders are disclosed. A system for digital asset management of the present invention may comprise a physical digital asset holder, wherein the physical digital asset holder may serve as a digital asset custodian, may facilitate a digital asset custodial service and/or may facilitate access or use of a digital asset held thereby. In some implementations, the system may comprise physical devices which may receive, hold and transfer digital assets, such as for example, cryptocurrencies, non-fungible tokens (NFTs) and the like. Such a physical device may also be referred to as a physical digital asset holder. The device(s) are physical digital asset holders that in some aspects may be similar to devices such as thumb drives, memory cards, SD cards or EVM chip and pin cards or gift cards and the like, however for use in the novel systems and methods for digital asset management, such devices may be configured as disclosed herein to serve as a digital asset custodian, may facilitate a digital asset custodial service and/or may facilitate access or use of a digital asset held thereby. A system of the present invention may assign (e.g. upload for holding thereby) a digital asset to the physical digital asset holder, wherein the physical digital asset holder may be a custodian of the digital asset held thereby and/or facilitate a custodial action related to the digital asset held thereby. A system of the present invention may assign (e.g. upload for holding thereby) a digital asset to the physical digital asset holder, wherein the physical digital asset holder may facilitate access or use of the digital asset held thereby. In some implementations, a physical digital asset holder may be configured to hold one digital asset, such as for example, an amount of a cryptographic currency, which in some implementations may be a value of a given denomination. In some implementations, the physical digital asset holder may be in a physical form similar to a coin, and may have an amount of a cryptographic currency of a given denomination assigned thereto, wherein the denomination may be discernable by a physical characteristic of the physical digital asset holder. In some implementations, a physical digital asset holder may be configured to have a plurality of digital assets assigned thereto, wherein one or more of the assigned digital assets may be accessed or used.

In some implementations, the system may transfer a digital asset from a physical digital asset holder in which it is held. For example, the system may transfer the digital asset from the physical digital asset holder to a user account (e.g. upload). In some implementations, such a transfer to a user account may be to a user account associated with a merchant, wherein the transfer is associated with a purchase transaction. In some implementations, the transfer may be associated with a sale of the digital asset being transferred, and the user account is associated with a purchaser of the digital asset. In some implementations, a transfer of a digital asset may be associated with a trade of digital assets, wherein the user account is associated with an entity party to the trade, and a receiver of the digital asset being transferred. In some implementations, the system may transfer one of more digital assets between physical digital asset holders. In some implementations, the system may trade (exchange) digital assets between physical digital asset holders. As noted. above, in some implementations, a physical digital asset holder may be used as tender paid to a merchant.

In some implementations, a physical digital asset holder may be configured for a plugin and/or wireless connection to a computing device, such as a computer, cellular device, smartphone, tablet, laptop and the like. In some implementations, a transaction terminal or station, similar to a point-of-sale payment terminal, a merchant payment terminal, a transaction station such as those for use with a subway MetroCard or the new One Metro New York (OMNY) system, and the like may facilitate transactions at the retail level that may be associated with a digital asset held by, or for assignment to a physical digital asset holder. In some implementations, a physical digital asset holder may hold only one digital asset. In some implementations, a physical digital asset holder may hold one or more digital assets. In some implementations, a transaction to which a physical digital asset holder is party, may be initiated with a “tap” gesture to a predetermined location of a transaction terminal, transaction station, or the like, wherein the “tap” may initiate a transfer of a digital asset, or a portion thereof, and in some implementations, such a transfer of a digital asset, or portion thereof, initiated by a “tap”, may be used, at least in part, to pay for goods or services.

In some implementations, a system or method of the present invention may facilitate user adoption of cryptocurrency by providing a point-of-transaction transfer or exchange of a digital asset, such as a cryptocurrency asset, thereby supplanting the use of an Automated Teller Machine (ATM) to convert between a cryptocurrency digital asset and a fiat currency. In some implementations, a physical digital asset holder and a digital asset thereon may be surrendered to a merchant for payment of goods or services. For example, a physical digital asset holder in a physical form comprising a physical indication of a denomination or amount of cryptocurrency held thereon, may be used as payment to a merchant (physically surrendered to the merchant), and such a physical embodiment of a digital asset may alleviate a merchant's concern with accepting digital currency which has previously not been available in a physical form for such transactions. In some implementations, a digital asset held by a surrendered physical digital asset holder may be transferred (uploaded) to a digital wallet, account or other financial repository of the merchant and thereby become readily liquid for use by the merchant.

A physical digital asset holder may hold cryptocurrency values of various amounts, such that a user may load a physical digital asset holder with a total amount of funds which may readily meet their needs for a given period of time. In some implementations, a system and method for digital asset management may include a user device, such as a smartphone, having a digital asset management application configured to interact with the physical digital asset holder to manage, access or use the digital asset held thereon. In some implementations, a user device having a digital asset management application may facilitate payment of goods and services using funds stored on a physical digital asset holder. In some implementations, payment may be rapidly facilitated wherein a programmable physical digital asset holder may send one or more parameters or information which may be required to effect a payment, such as a physical digital asset holder ID, a digital asset type, a digital asset ID, a digital asset value and/or a digital asset authentication code, to a user device, wherein a user device may then use the parameter or information to make payment using the digital asset. In some implementations, a physical digital asset holder and a user device may be configured to communicate wirelessly, such as communicate using near-field communication (NFC), and to initiate such communication using a gesture, such as a tapping gesture between the physical digital asset holder and the user device, wherein a user may tap a physical digital asset holder with their smartphone, and parameters and information required to effect payment using a digital asset thereon are transferred to the smartphone, allowing a user to review payment related details and authorize payment using their smartphone. In some implementations, a user may use a first gesture to communicate parameters and information associated with a digital asset from a physical digital asset holder to a user device, such as a smartphone, and use a second gesture to make a payment using a digital asset comprised by the physical digital asset holder, wherein the second gesture is a tap to pay gesture between the smartphone and a merchant payment device, such as a merchant payment terminal, thereby initiating an NFC session between the user's smartphone and merchant payment device to effect a payment using a digital asset held by the physical digital asset holder.

In some implementations, a user may download a digital asset management application to a user device, such as an Android or iOS-based device, such as a smartphone, wherein the user device may be used to load a digital asset onto a physical digital asset holder. In some implementation, a process to load a digital asset onto a physical digital asset holder may include the steps of connecting a funding source (e.g. Wallet, bank account, etc.) to the digital asset management application, entering parameters and information to identify or define a digital asset to be loaded, or to create and load a digital asset. In some implementations, a user may initiate the loading of the digital asset to the physical digital asset holder using a tap (or touch) gesture to the physical digital asset holder with the user device, such as a smart phone. In some implementations, a user may use a manual entry of an input (e.g., touch a “load digital asset” button displayed on a touchscreen display of the user device) to initiate the loading of the digital asset to the physical digital asset holder. In some implementations, the process of loading the digital asset onto the physical digital asset holder may involve connecting a communications cable between the user device and the physical digital asset holder. In some implementations, wireless communications, such as Bluetooth or a wireless LAN may be used to communicate between to physical digital asset holder and the user device in order to load a digital asset onto the physical digital asset holder. In some implementations, an NFC technology may be used to communicate between to physical digital asset holder and the user device in order to load a digital asset onto the physical digital asset holder

A physical digital asset holder may be embodied in one of a plurality of physical forms, such as, but not limited to, a physical form of a digital coin, a physical form of a digital card (e.g., a digital playing card, a digital gaming card, a digital collectable card, a payment card, etc.), a physical form of a digital picture frame, a physical form of a digital diner payment tray, a physical form of a digital music player, just to name a few possible physical forms in which a physical digital asset holder may be embodied. A physical form in which a physical digital asset holder is embodied may reflect a possible use or application of a physical digital asset holder, such as for example, a physical from of a coin or a payment card may be used for a physical digital asset holder to be used for payment using a cryptocurrency digital asset, or a physical from of a digital picture frame may be used for a physical digital asset holder to be used for display an NFT artwork digital asset. As another example, a physical form of a digital music player may be used for a physical digital asset holder to be used for playing a musical audio track digital asset. In some implementations, a physical digital asset holder may be used as a digital card which may be used in a collectable card game (CCG), such as Magic the Gathering (MTG), Pokeman, Yu-gi-oh, etc., as an alternative to a paper card. In some implementations, a physical digital asset holder may be in a physical form of a digital collectable card for a CCG, wherein digital assets, such as NFTs, for digital cards may be held thereon resulting in one or more digital cards being housed in, and useable from, a single physical digital asset holder. In some implementations, a device usable for playing a CCG, such as a game console or other computing device, may be configured to interact with a physical digital asset holder. In some implementations, a user device, such as a smartphone, may be configured to interact with a physical digital asset holder comprising digital CCG card assets. For example, traditionally when a player competes at a CCG tournament, they have to write down their card list, wherein a suitably configured CCG or application on a user device may simply produce a list of digital cards held on the physical digital asset holder that are associated with the CCG. In some implementations, a user may do a digital search of NFT digital assets through their purchased virtual cards for a particular card rather than physically sort through a physical card collection. Such digital searching, listing, loading and access of NFT digital assets of virtual cards for CCGs may be useful for tournament directors or others who may set up and manage a plurality of physical digital asset holders for a plurality of CCG cards, and configure a CCG and players card assets in preparation for, and during game play. Furthermore, operations such as a random auto-shuffle of CCG cards during a game or shuffling at a starting a new CCG may be done programmatically when using physical digital asset holders which comprise the cards in digital form of NFT digital assets. NFT digital asset based CCG playing cards allow a programmatic mucking of cards such that a player doesn't have to muck their cards after a fold. In some implementations, a physical digital asset holder may be embodied in a physical form of a playing card, wherein the physical digital asset holder is two-sided such that one side may display NFT artwork representing a CCG game card held by the physical digital asset holder, and the other side may comprise a touchscreen wherein game-play functions such as folding, options raising, calling, etc. can be through pressing associated selections on a physical digital asset holder's non-game card surface touchscreen, thereby keeping the same physical digital asset holder comprising the NFT digital asset based CCG cards in front of them over multiple playing sessions of CCGs. In some implementations, a physical digital asset holder embodied in the physical from of a CCG card, may comprise a touchscreen display for receiving user input, in some implementations it may comprise physical buttons, and in some implementations, it may comprise both. In some implementations, CCG cards held as NFT digital assets on a physical digital asset holder, and/or the physical digital asset holder may have game related functions or digital features such as, life counters, loyalty-counters, simulated dice rolling, in-game counters, moving graphics, virtual card flipping (i.e., switching images between the two sides of a physical digital asset holder embodied in the physical form of a CCG card without physically having to turn it over), and/or more than two side images, such that the virtual card may display three or more sides. In some implementations, physical digital asset holders may be embodied in the physical form of a game figure or other game features, such that a video game could have a physical digital asset holder embedded in a figurine or other game piece, and hold digital assets for figures, weapons, skins, equipment, maps, etc., wherein a video game may be configured to receive and process information regarding the digital assets, and update a player's profile to comprise the game figure and game features stored as digital assets thereon accordingly.

In some implementations, CCG NFT digital asset based playing cards may be elected/selected and may be uploaded to a plurality of physical digital asset holders. For example, in the case of a standard MTG deck, each player has a 60 card deck. In some implementations, an NFT physical digital asset holder for CCGs may be made from double-sided flexible OLED display screens or other similar screen technology. In some implementations, trading between owners of NFT digital asset based CCG playing cards may be facilitated by a system and method for managing digital assets comprised by physical digital asset holders, such that users can perform even trades of NFT digital assets of equal value, or trade unequal values of NFT digital assets and account for the difference with a crypto currency digital asset to result in an equal value trade in total, wherein the system for managing digital assets effects the trade by transferring the traded assets between physical digital asset holders of the respective parties engaging in the trade. In some implementations, a digital asset management application on a user device may be configured to enable a user to research and/or receive NFT digital asset prices, such as market prices for NFT digital assets, or subscribe to live pricing updates for NFT digital assets, when evaluating a potential NFT digital asset trade and determining a value difference for establishing a value of a cryptocurrency digital asset required to make the trade an equal value trade, wherein the cryptocurrency digital asset can be exchanged at the time the NFT digital assets are exchanged (i.e. traded) or be moved to a user wallet or transferred at a later time other than the time the NFT digital asset trade is done.

In some implementations, a physical digital asset holder may be powered using an solar cell integrated therein, In some implementations, a physical digital asset holder may be powered using batteries, such as rechargeable batteries or non-rechargeable batteries. In some implementations, a physical digital asset holder may be powered using an integrated coiled conductor configured to receive inductive power transmitted thereto. In some implementations, a digital asset hold may be powered by an external power source connected by a wire cable attached thereto. In some implementations, a physical digital asset holder may comprise or be configured to operate with more than one of the aforementioned power sources.

In some implementations, a physical digital asset holder may be managed using a digital asset management system, wherein a computing device, such as a user smartphone, a desktop computer, a tablet computer, a laptop computer, networked server computer or other computing device may be configured to managed digital assets of the physical digital asset holder, such as transfer assets to or from the physical digital asset holder. In some implementations, such a computing device may also communicate or set other data, parameters or information within the physical digital asset holder, such as associated account information of a user, and data and parameters associated with security protocols, and the like. In some implementations, data, parameters or information within a physical digital asset holder may be manually set without a computing device, such as a user smartphone or other computing device, wherein the physical digital asset holder comprises a processor and instruction code which when executed by the processor configures a user input device such as a touchscreen display, integrated into the physical digital asset holder, to facilitate a manual input of data, parameters or information. In some implementations, an example process for entering data, parameters or information using a smartphone may include the following steps:

1. Download a digital asset management application, which may be available for both an IOS and Android based smartphone.

2. Enter data, parameters or information on an appropriate display screen of the smartphone.

3. Use a gesture, such a touch the smartphone to the top of the physical digital asset holder to initiate an NFC transfer of the data, parameters or information to the physical digital asset holder, or select an appropriate response to a prompt displayed on the integrated touchscreen display to initiate a wired or wireless (depending on the configuration of the physical digital asset holder) transfer of the data, parameters or information to the physical digital asset holder. In some implementations, the smartphone and/or physical digital asset holder may have an audio indication (e.g. a “beep”) or other notification(s), such as a display message notification, email notification, text message notification, and the like, wherein such notifications may be received in the case of a digital asset transaction between multiple parties.

In some implementations, a physical digital asset holder will have a serial number or other unique code encoded internally (e,g. on an an integrated circuit, or “chip”) and/or externally on the casing unless. Data, parameters and information may be entered via a computing device as described above, wherein such information may include a unique digital asset identifier and cryptographic hash generated by a blockchain ledger system securing the digital asset, an owner identifier, a transaction identifier, digital asset type (e.g. cryptocurrency and type of cryptocurrency, NFT type/specifier, etc.), where applicable an amount (e.g. amount of cryptocurrency) and the like, when setting (loading a digital asset into) the physical digital asset holder. In some implementations, loading or making an ownership transfer of a digital asset, may require a successful challenge by the computing device, such as use an Authenticator (e.g. Real-time Google Authenticator that changes codes every so many seconds) or other multi-factor authentication scheme to secure the transaction. In some implementations, a key, such as an encryption key, or pin number of other secret information, may be given to a user to enter into the physical digital asset holder via the user's device, as a passcode or challenge to be validated by the physical digital asset holder and/or user device to validate the legitimacy of the digital asset transaction prior to making a transfer of the digital asset and a recordation of the transaction by a digital asset ledger, such as a blockchain ledger. In some implementations, a QR code, barcode, or other indicia or similar readable data technology may be encoded on the physical digital asset holder to validate or corroborate the physical digital asset holder and or other user information that was entered. For example, in some implementations the smartphone may prompt the user to read a QR code on the physical digital asset holder using the smartphone camera, and this may be used corroborate a physical digital asset holder's serial number, wherein if the corroboration step fails, the digital asset management system does not complete an associated transfer of a digital asset. In some implementations, a relinquishing party of a digital asset may select an option to receive notifications regarding the status of a digital asset transfer. In some implementations, multi-factor authentication may be used and be based on different combinations authentication factors (e.g. phone number, pass phrase, password, id, various user generated keys, etc.), wherein, if the multi-factor authentication step fails, the digital asset management system does not complete an associated transfer of a digital asset. In some implementations, additional security features may include three-digit or four-digit CVV codes, packaging scratch-offs and/or physical digital asset holder packaging scratch-off codes similar to gift cards, wherein a user would need to enter the such additional security information or security components correctly and if the entered information is incorrect, the digital asset management system does not complete an associated transfer of a digital asset.

In some implementations where a merchant is party to a digital asset transaction comprising a physical digital asset holder, a user may effect a transfer using a customer activated merchant payment terminal. In some implementations, a merchant may effect a digital asset transfer, wherein after a completed digital asset transfer transaction, a merchant could return either a blank or non-blank physical digital asset holder, the latter being a scenario where more funds were on the physical digital asset holder than the payment amount. In some implementations, a user may use or provide more than one physical digital asset holder each having a portion of the funds needed to pay a total amount required for a transaction, as is done in a multiple tender point of sale transaction, wherein funds on multiple physical digital asset holders could be used to complete a transaction.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of the disclosed subject matter.

FIG. 1 depicts a system diagram of an example implementation of a digital asset management system comprising a physical digital asset holder.

### DETAILED DESCRIPTION

Various detailed example implementations of systems and methods for digital asset management comprising physical digital asset holders are disclosed herein; however, it is to be understood that the disclosed implementations are merely illustrative and may be embodied in various forms. In addition, each of the examples given in connection with the various implementations is intended to be illustrative, and not restrictive.

The following detailed example implementations refer to the accompanying drawings. The same reference number may appear in multiple drawings and when appearing in multiple drawings will identify the same or similar elements.

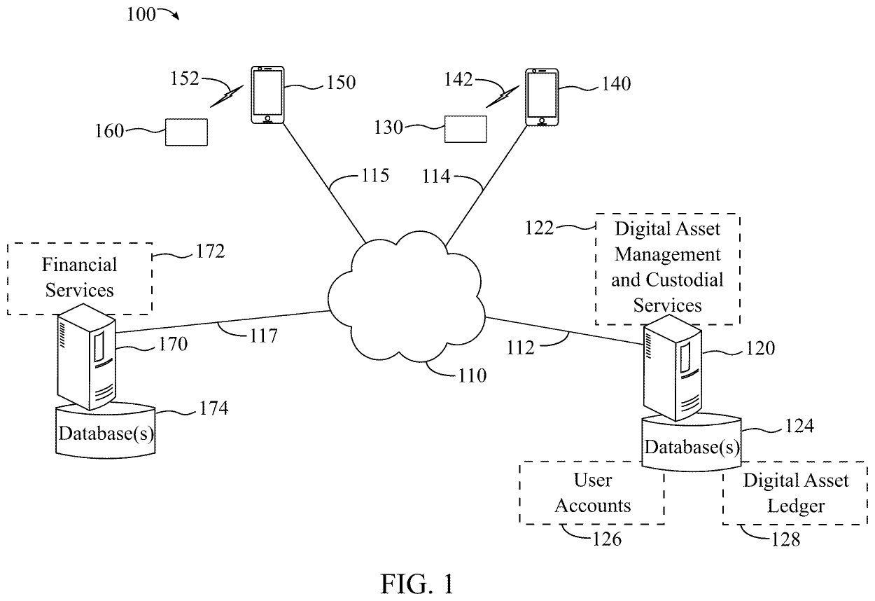

FIG. 1 depicts a system diagram of an example implementation of a digital asset management system 100 comprising a physical digital asset holder of the present invention. Digital asset management system 100 comprises a digital asset management server 120, wherein digital asset management server 120 has digital asset management and custodial application services software 122 running thereon. Digital asset management service 120 in connected to a communications network 110 via a communications link 112. Digital asset management server 120 is connected to digital asset management database(s) 124 and maintains data associated with user accounts 126 which are associated with users of the digital asset management system, and a digital asset ledger 128 which comprises a blockchain ledger comprising secure records associated with digital assets.

Digital asset management system 100 comprises a user device 140, which may be a computing device, such as a smartphone, laptop computer, tablet computer, or other computing device. User device 140 is connected to communications network 110 via a communications link 114. Digital asset management system 100 comprises a physical digital asset holder 130, wherein user device 140 may communicate with physical digital asset holder 130 via a wireless communications link 142. Digital asset management system 100 may comprise a merchant device 150 which may be a computing device such as a point of sale terminal, merchant payment terminal, smartphone, laptop computer, tablet computer, or other computing device. Merchant device 150 is connected to communications network 110 via a communications link 115. Digital asset management system 100 comprises a physical digital asset holder 160, wherein merchant device 140 may communicate with physical digital asset holder 160 via a wireless communications link 152.

Digital asset management system 100 may be connected to a financial services server 170, via communications network 110 and communications link 117. Financial services server 170 has financial services software 172 running thereon, and is connected to financial services database(s) 174 and maintains data associated with user financial accounts thereon.

A number of implementations of a user configurable storage and display apparatus have been described. Various modifications may be made without departing from the spirit and scope of the disclosed systems and methods for digital asset management comprising physical digital asset holders.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

A number of implementations of systems and methods for digital asset management comprising physical digital asset holders have been described. Various modifications may be made without departing from the spirit and scope of the invention.

What is claimed is:

1. A digital asset management system comprising:
a physical digital asset holder comprising a unique code uniquely identifying the physical digital asset holder;
a digital asset ledger comprising digital asset records associated with a plurality of digital assets, wherein each digital asset record associates a digital asset to an owner, wherein the owner is an entity and the physical digital asset holder is an entity identifiable by the unique code comprised thereby;
a user account configured to receive authorization for transfer of an authorized digital asset and to specify the physical digital asset holder as a receiving owner of the authorized digital asset; and
a user device configured to facilitate transfer of the authorized digital asset to the physical digital asset holder, wherein:
the user device is authenticated with the user account to which the authorized digital asset is authorized;
the user device communicates with the physical digital asset holder to retrieve the unique code uniquely identifying the physical digital asset holder;
the user device communicates, to the digital asset ledger, the unique code uniquely identifying the physical digital asset holder and requests transfer of the authorized digital asset thereto; and
the user device receives a message, from the digital asset ledger, confirming transfer of the authorized digital asset to the physical digital asset holder.

2. The digital asset management system of claim 1, wherein the physical digital asset holder is embodied in a digital playing card.

3. The digital asset management system of claim 1, wherein the physical digital asset holder is embodied in a digital coin.

4. The digital asset management system of claim 1, wherein the physical digital asset holder is embodied in a digital picture frame.
